(19) United States
(12) Patent Application Publication
(10) Pub. No.: US 2025/0348732 A1
(43) Pub. Date: Nov. 13, 2025

(54) Memory Efficient Attention Window Expansion For Trained LLMs

(71) Applicant: Samsung Electronics Co., Ltd., Suwon-si (KR)

(72) Inventors: Hamza Naseem Mohammed, Albany, CA (US); Sai Chand Boyapati, San Jose, CA (US)

(21) Appl. No.: 19/192,964

(22) Filed: Apr. 29, 2025

Related U.S. Application Data
(60) Provisional application No. 63/644,867, filed on May 9, 2024.

(51) Int. Cl. G06N 3/08; G06N 3/0455

(52) U.S. Cl. CPC G06N 3/08; G06N 3/0455

(57) ABSTRACT

In one embodiment, a method includes predicting, by a decoder of an LLM and in response to an input sequence provided to an encoder of the LLM, s tokens of an output sequence. The method further includes accessing, for each of one or more attention layers of the LLM, a set of attention logits specific to that attention layer and used by the LLM to predict the n most recent tokens of the s tokens; determining, for each of the one or more attention layers and by a trained mask generation model, a layer-specific attention mask for the set of attention logits specific to that attention layer; and predicting, by the decoder of the LLM, the next m tokens of the output sequence using the set of attention logits as masked by the layer-specific attention mask for each layer.

### PRIORITY CLAIM

This application claims the benefit under 35 U.S.C. § 119 of U.S. Provisional Patent Application No. 63/644,867 filed May 9, 2024, which is incorporated by reference herein.

### TECHNICAL FIELD

This application generally relates to techniques for memory efficient attention window expansion for trained LLMs.

### BACKGROUND

A large language model (LLM) is a type of machine-learning model designed for natural language processing tasks, such as language generation. LLMs have many parameters and are trained on very large corpuses of natural-language input. LLMs typically have multiple layers of neural networks, each with parameters that can be tuned during training, and also have multiple attention layers, which focus on specific portions of a token sequence.

To perform natural-language tasks, LLMs operate on embedded token sequences, which are numerical representations of portions of natural language. There is a wide variance in the amount of text that one token can represent: a token can represent a single character, a part of a word (such as a suffix or prefix), a whole word, or a multiword phrase. Different LLMs can have different embeddings and tokenization of the same natural-language input, based on their architectures and training.

An LLM's context window determines how much an LLM's output can be influenced by the LLM's prior natural-language input and output, similar to how a phrase's meaning can be informed in conversation or in writing by nearby words that are not directly part of the phrase. By effectively managing larger contexts, LLMs can maintain coherence over long conversations, helping virtual assistants and chatbots to provide relevant and accurate responses based on dialog history. Moreover, the ability to sift through vast quantities of information to identify specific data points allows for more efficient knowledge discovery and decision-making in natural-language tasks. An LLM's context window requires computer memory, often GPU memory, to store relevant contextual information.

### BRIEF DESCRIPTION OF THE DRAWINGS

FIG. 1 illustrates an example memory efficient attention window expansion method for trained LLMs.

FIG. 2 illustrates an example architecture for implementing the example method of FIG. 1.

FIG. 3 illustrates an example of a layer-specific attention mask output by a mask generation model.

FIG. 4 illustrates an example computing system.

### DESCRIPTION OF EXAMPLE EMBODIMENTS

Increasing an LLM's context window improves the LLM's performance on natural-language tasks, but also increases the memory resources required to store that context. In addition, the memory used by an LLM is typically GPU memory, which can be particularly resource-intensive to scale. Moreover, when LLMs use deep attention mechanisms, which provide superior performance, the memory requirements scale quadratically with context length (i.e., doubling the context window requires 4 times as much memory). Thus, an LLM's context window is typically limited by the available memory to store context. This is particularly true for edge-deployed LLMs, (e.g., LLMs deployed on client devices such as personal computers, smartphones, etc.), which typically have fewer computational resources than do server-deployed LLMs, although both types of deployments have context windows that are constrained by memory limitations.

Apart from adding more memory, one approach for increasing an LLM's context window is to re-train the LLM with curated datasets that contain large inputs or outputs. However, LLM model training is a very expensive and resource-intensive process, and is often impractical. Other approaches use inference-time techniques to increase an LLM's context window without having to re-train the entire model. For instance, inference-time techniques may use an attention mask to increase the attention window, but such masks are either static (i.e., stay the same for each LLM layer and for each iteration) or are based on statistical evaluations of a particular LLM's architecture. In real-world use cases, these approaches suffer from poor performance.

In contrast, the techniques of this disclose use a variable, layer-specific attention mask computed by a trained mask-generation model during inference. As described below, these techniques can modify the layer-specific attention masks during inference as the attention logits in a particular layer evolve during inference iterations. As explained below, by using a variable mask that looks at attention logits at each layer for previous tokens generated, these techniques can focus each layer's attention window towards tokens that yield the largest attention logits, regardless of their position. These techniques do not require model retraining, and can be used in conjunction with other LLM optimizations. Moreover, the adaptive masked attention generation techniques described herein (in conjunction with sparse attention kernels, in particular embodiments) increase the effective attention window of an LLM, for example enabling the model to maintain constant or near-constant context window memory overhead while achieving near loss-less long context performance, in particular embodiments.

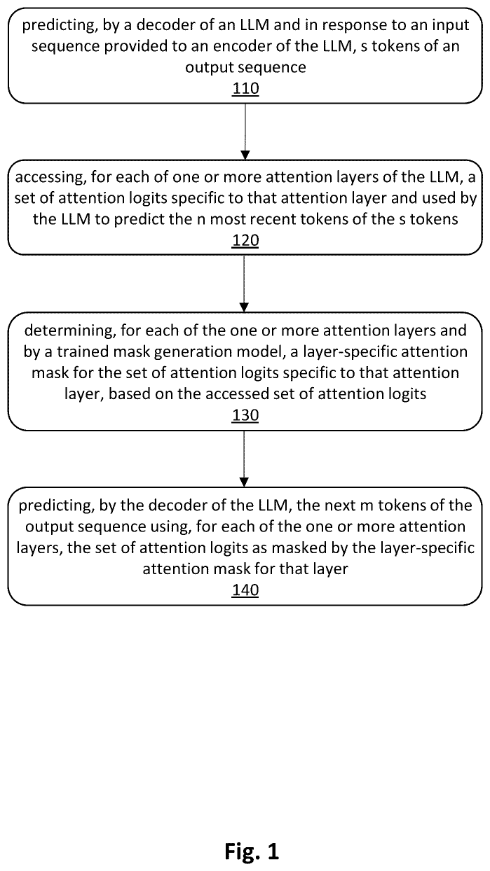

FIG. 1 illustrates an example memory efficient attention window expansion method for trained LLMs. Step 110 of the example method of FIG. 1 includes predicting, by a decoder of an LLM and in response to an input sequence provided to an encoder of the LLM, s tokens of an output sequence. The input sequence is typically text input (e.g., text provided by an end user, transcribed verbal input from a user, etc.), and the decoder determines the corresponding natural-language input for the task. The s tokens represents s iterations of the inference task performed by the LLM decoder.

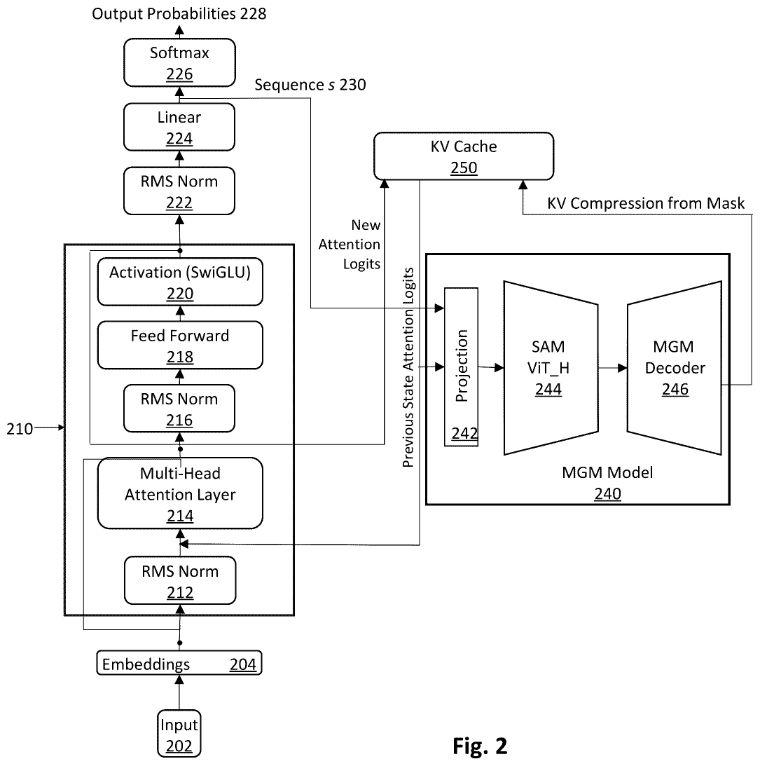

FIG. 2 illustrates an example architecture for implementing the example method of FIG. 1. In the example of FIG. 2, input 202 is provided to an LLM and is encoded by the LLM's encoder. The LLM's text-generation architecture is shown in FIG. 2, which includes an embedding layer 204 for embedding input 202. The LLM of FIG. 2 includes multiple transformer blocks 210, each of which include an RMS normalization layer 212, a multi-head attention layer 214, an RMS normalization layer 216, a feed forward layer 218, and an activation layer 220. The output of the transformer blocks are sent to another RMS normalizing layer 222, a linear layer 224, and a softmax layer 226. The output probabilities 228 are then used to determine the final sequence that the LLM will generate in response to some input. The example of FIG. 2 illustrates a particular architecture of an LLM text-generation model, and illustrates only a single instance of various layers when in reality multiple such layers are used in an LLM decoder; this illustration is for example purposes only and the techniques described herein are not limited to the specific architecture shown in FIG. 2.

In the example of FIG. 2, sequence s 230 represents the output sequence of the LLM after s inference iterations. At each inference iteration, each attention layer 214 determines a new set of attention logits based on the cached attention logit values for that layer stored in that layer's KV cache 250. Typically, an attention layer 214 will write a new row of attention logits to its KV cache 250 during each iteration. An LLM has many attention layers, each with its own KV cache (or dedicated portion of a KV cache), and each of which has its own set of attention logits that will influence the overall output sequence s.

Step 120 of the example method of FIG. 1 includes accessing, for each of one or more attention layers of the LLM, a set of attention logits specific to that attention layer and used by the LLM to predict the n most recent tokens of the s tokens in the output sequence. In other words, at the conclusion of the sth inference iteration (where s is one or more), then for each of one or more attention layers (e.g., all the attention layers, or just some of the attention layers of the LLM), the attention logits specific to that attention layer and used to predict the most recent n tokens are accessed. As explained above, the attention logits are typically stored (in indexed form) in a KV cache, and the attention logits for a specific attention layer referenced in step 120 are typically accessed from the KV cache (although, in particular embodiments, such logits may be accessed by logging those logits from the respective attention layer).

The most recent n tokens are accessed from the s tokens, where n is less than or equal to s. In particular embodiment, n is a hyperparameter. In particular embodiments, n may vary among iterations of the method of FIG. 1, and/or may vary among attention layers (e.g., n may take a different value for different attention layers). In other embodiments, n is a hyperparameter that that is the same for each of the one or more attention layers (e.g., all the attention layers) referenced in step 120.

Step 130 of the example method of FIG. 1 includes determining, for each of the one or more attention layers and by a trained mask generation model, a layer-specific attention mask for the set of attention logits specific to that attention layer, based on the accessed set of attention logits. In the example of FIG. 2, mask generation model (MGM) 240 includes a projection 242, which linearizes the matrix of logit values and, in particular embodiments, concatenates sequence s 230 to that linearized vector. The attention logits for a particular layer accessed in step 120 are then input (e.g., after projection) to an encoder 244 and decoder 246, which are trained to output an attention mask based on the input attention logits. In particular embodiments, the input attention logits may be represented via a heatmap.

In particular embodiments, the encoder and decoder of a mask generation model may be vision transformers that are fine-tuned for the mask generation task. For instance, an MGM may be a compact transformer encoder adapted from ViT-base of the SAM ViT-H model, with 6 layers, hidden size of 512, 8 attention heads, and a feed-forward dimension of 2048, although other parameters may be used.

In the example of FIG. 2, MGM 240 takes as input a low-dimensional projection of the current token embeddings and outputs a sparse mask M∈0, 1^{N×N}, where N is the sequence length. In particular embodiments, the mask generation may be informed by a hyperparameter k, e.g, (M=TopK(Sigmoid(F),k)). In particular embodiment, an MGM specifically interacts with the decoder-only masked attention layers of the VLM, i.e. the decoder-only masked LLM component of the VLM.

In particular embodiment, an MGM may be trained on a diverse corpus of attention patterns sampled from various VLMs and tasks from a long-context subset of particular datasets, minimizing the loss, such as the binary cross-entropy loss, between the predicted mask and the ground truth sparse attention patterns. Other examples of loss mechanisms includes IOU (intersection over union or dice) loss, weighted (or focal) binary cross entropy or cross entropy loss, and KLD (Kullback-Leibler divergence) loss, and this disclosure contemplates that any suitable loss mechanism may be used. To adapt the MGM to specific VLMs and downstream tasks, particular embodiments may employ reinforcement learning. For example, particular embodiments may employ Odds-Ratio Preference Optimization (ORPO), which fine-tunes the MGM by recursively optimizing its parameters based on the output of the target VLM. The value of kin the TopK operation is, in particular embodiments, dynamically adjusted based on the current context length and a target sparsity ratio r:k=max(kₘᵢₙ, min(kₘₐₓ, round(r·N))). The sparse attention operation may be computed as

$$A = softmax ( \frac{Q {K}^{T} ⊙ M}{\sqrt{d}} ) and O = AV ,$$

where Q, K, and V are the query, key, and value matrices respectively, and G denotes element-wise multiplication. To optimize this operation, particular embodiment implement a revised CUDA Triton kernel that efficiently handles the sparse matrix multiplication and softmax operations. Particular embodiments may incorporate shared memory usage, warp-level primitives for efficient parallel reduction, and block-sparse matrix multiplication for the QK^{T} operation.

In particular embodiments, an MGM may be fine-tuned on a synthetic dataset created by sampling attention patterns from the LLM across various tasks and input sequences. For example, a dataset may include pairs (A_{t-n:t-1}, Mₜ), where A_{t-n:t-1} are the attention logits from the previous n tokens, and Mₜ is the corresponding optimal attention mask at time (i.e., iteration) t.

Training may be performed, in particular embodiments, using the Adam optimizer with a learning rate of, e.g., 1e-4 and a batch size of 8 (gradient accumulation to avoid OOM). Early stopping may be employed based on validation loss to prevent overfitting. Training may run for a number of epochs (e.g., 3), with cosine learning rate and warm up ratio of 0.1, with early stoppage if loss stabilizes.

To adapt VLM with MGM integration, particular embodiments may use ORPO. For instance, starting from a LLaMA 3.2 90B Vision Instruct model, with the help of quantized ORPO particular embodiments train and preference-align on a single 48 GB GPU (A6000) with CPU offloading (through DeepSpeed ZeRO Stage 3), or on two 48 GB GPUs (2×A6000) for faster training.

For training, particular embodiment may use a dataset with a number of samples (e.g., 1,200) compiled from an internal long context visual document retrieval dataset (extracting product information, UI context, and user flows from PDFs) to answer related questions from FAQ Question Answer pairs. Particular embodiments may first augment the dataset with negative samples (incomplete variants, and merged variants), and context mapping samples (samples with manual context retrieved and appended to questions), for a total of, e.g., 12,000 samples. Particular embodiment may then run training for 3 epochs with cosine learning rate scheduler, with learning rate starting at 1e-5, warmup ratio of 0.1, and batch-size of 8 (gradient accumulation to avoid OOM errors), using the 8-bit Adam optimizer, with early stoppage if loss stabilizes. For preference optimization in ORPO, particular embodiments may use beta=0.1.

The above description regarding specific training approaches and parameters for particular mask generation models are for example purposes only, and are not exhaustive. This disclosure contemplates that other training parameters and procedures may be used to train a mask generation model based on input training and ground-truth data. For instance, particular embodiments may take the output of a high-quality (e.g., GPT) LLM model for a given input and use as ground truth what the MGM model's sparse attention would be in order to generate the same sequence as generated by high-quality model. Moreover, while certain examples described above use a vision transformer architecture for the mask generation model, this disclosure contemplates that other encoder-decoder architectures may be used to output the layer-specific attention mask based on the attention logits for that layer from the previous n iterations.

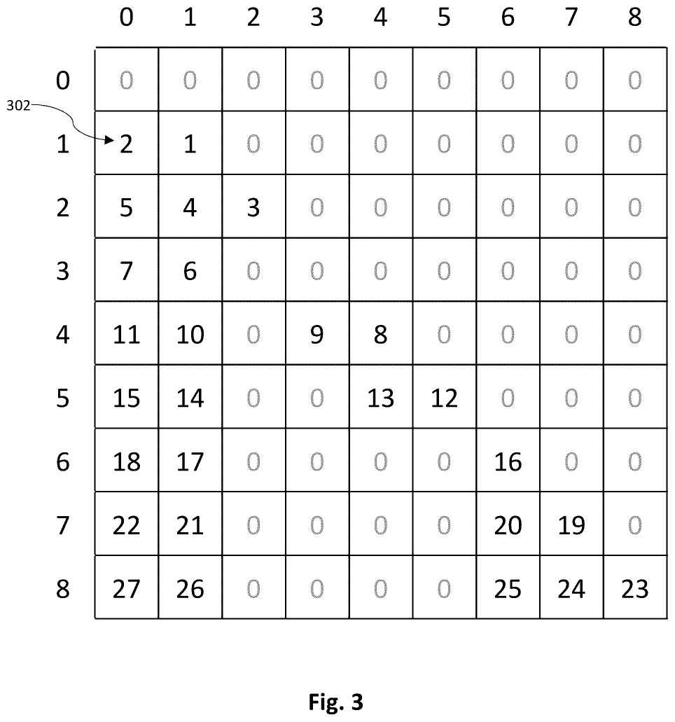

FIG. 3 illustrates a simple example of a layer-specific attention mask output by a mask generation model. Each value is a logit, and its value is the attention of token r for token c (basically, the key (K) times the value (V)), where r is the row index and c is the column index. For instance, logit 302 has a value 2 and is indexed by r=1 and c=0. As illustrated in the example of FIG. 3, the mask generation model allocates attention in the mask in a non-uniform manner. For instance, in the example of FIG. 3, several logits are masked (i.e., are given the value 0). By modifying the attention mask to ignore regions with lower allocation, the techniques described herein increase the effective attention window for the LLM.

Step 140 of the example method of FIG. 1 includes predicting, by the decoder of the LLM, the next m tokens of the output sequence using, for each of the one or more attention layers, the set of attention logits as masked by the layer-specific attention mask for that layer. Specifically, each attention layer outputs logit values to the next layer, and these logit values are typically stored in the KV cache. Thus, a layer-specific mask is used to modify the logit values for its layer, which are then used by the subsequent layer during the m inference iterations.

In particular embodiment, m is a tunable parameter that determines how many iterations of the output sequence will be performed before the layer-specific mask is updated. In other words, the attention mask is used to generate sparse attention logits for its corresponding layer. That set of sparse attention logits is then used for m iterations (i.e., to predict the next m tokens following the s tokens that have already been predicted). As illustrated in the example of FIG. 2, each layer's attention mask may be used to compress the KV cache, which stores the indexed value of the attention logits for a specific layer. In particular embodiment, the indices of removed logits (i.e., logits given the value of 0 in the attention mask) may be preserved so that if the attention layer refers to those logits in the next m iterations, a zero value is returned for that reference.

The method of FIG. 1 may be repeated iteratively for a particular inference task. In particular embodiments, n and m may have a fixed particular value during iterations of the method of FIG. 1 for a particular inference task. In other embodiments, either or both of n or m may vary among at least some of the iterations (e.g., m may be 16 in the first iteration, and may take a larger or smaller value in the next iteration, etc.).

In particular embodiments, such as the example of FIG. 2, a mask generation model generates a layer-specific mask based on both (1) the attention logits for the previous n sequence iterations and (2) the previous sequence (e.g., sequence s 230). For example, the sequence s may be concatenated with the linearized vector of logit values, and this concatenated vector may be input via projection 242 to encoder/decoder 244 and 246 to generate the layer-specific attention mask. Doing so improves the attention allocation of the mask, for example by taking into account attention allocation across the full set of layers (as evidence by the sequence s), in addition to the layer-specific attention logits in the KV cache.

In particular embodiments, an iteration of the example method of FIG. 1 may evaluate a deviation, or difference, between the attention in the sequence s and the masked attention for particular layer as identified by the masked attention logit values (e.g., the masked values in the KV cache for that layer). If the difference is greater than a threshold, this indicates that the layer-specific mask attenuated attention for a particular layer in areas that globally (looking at the attention output from all layers) are in fact relevant to the output sequence. For example, suppose token IDs 4-6 are given zero attention by a mask for a particular layer, but the sequence s indicates that the attention for IDs 4-6 is relatively high. This indicates that the layer-specific mask is deviating from the global attention values determined by the LLM's full text-generation model.

In such instances, particular embodiments may revert that layer's attention logit values to their previous values (i.e., the values that were present before the most recent instance of the applied mask) and then regenerate a mask for those logits. In particular embodiments, mask generation may be a stochastic process, such that recompression will alter the attention logit values from those that previously led to a too-large deviation. These approaches prevent masking from deviating a layer's attention logits too far from the overall attention values present in a particular sequence s. In particular embodiments, these differences may be evaluated during each iteration of the example method of FIG. 1 (e.g., every m inference iterations). In other embodiments, these differences may be evaluated more frequently (e.g., at every inference iteration).

Thus, by using global attention and model output to dynamically verify and optimize the eviction and scarification steps, particular embodiments may outperform existing cache compression or dynamic attention approaches that employ fixed strategies, i.e. they tend to blindly follow their compression or sparsification strategies without verifying and dynamically adapting based on global attention and model output.

Algorithm 1 below, also referred to as the CALC-LLM (context-adaptive layerwise compression for LLMs) algorithm, illustrates a particular implementation of the example method of FIG. 1 that also evaluates the deviation between mask logit values and a sequence.

Algorithm 1 CALC-LLM

Require: Previous attention logits A_{t-n:t-1}, input sequence X, hyperparameters n, m, k

| | |
|---|---|
| 1: | Initialize Mask Generation Module (MGM) with pretrained parameters |
| 2: | Initialize Key-Value (KV) Cache |
| 3: | for each token step t in input sequence X do |
| 4: | if t mod m = = 0 or significant change detected then |
| 5: | Generate attention mask M using MGM: M = MGM(A_{t-n:t-1}, X) |
| 6: | Apply adaptive KV-cache compression based on layer-wise sparse configuration |
| 7: | end if |
| 8: | Apply mask M to attention logits: Ã = A ⊙ M |
| 9: | for each query qᵢ in Ã do |
| 10: | Select top-k keys based on Ã_{i,:}: top_k_keys = TopK(Ã_{i,:}, k) |
| 11: | Compute attention output using selected keys and values: |
| 12: | Output = Σ(softmax(Ã_{i,top}_{_{—}}ₖ_{_{—}}_{keys}) · Vₜₒₚ_{_{—}}ₖ_{_{—}}_{keys}) |
| 13: | end for |
| 14: | Update positional embeddings using dynamic NTK scaling |
| 15: | Generate next token using updated attention mechanism |
| 16: | Update and compress KV-cache with attention output and sparse configurations |
| 17: | end for |
| 18: | Return the generated tokens and compressed KV-cache |

In the example implementation of algorithm 1, k may be determined based on the amount of available memory to store context. In particular embodiments, k may vary from layer to layer.

CALC-LLM combines dynamic sparse attention with adaptive KV-cache compression to enable efficient processing of long sequences in VLMs. This approach leverages a lightweight Mask Generation Model (MGM) to dynamically generate sparse attention patterns, coupled with a novel adaptive compression technique for the KV-cache. The adaptive KV-cache compression technique combines frequency-based and recency-based importance scoring. For each key-value pair (kᵢ, vᵢ) in the cache, particular embodiments maintain a frequency counter fᵢ and a timestamp tᵢ of the last access. The importance score for each pair may be computed as

$${S}_{i} = α \cdot \frac{{f}_{i}}{max ( f )} + ( 1 - α ) \cdot ( 1 - \frac{{t}_{current} - {t}_{i}}{{t}_{window}} ) \qquad ( 1 )$$

where α balances frequency and recency, max(f) is the maximum frequency across all pairs, t_{current} is the current timestamp, and t_{window} is a sliding window size. Based on these scores, particular embodiments apply a dynamic compression ratio to each pair: CRᵢ=CRₘₐₓ−(CRₘₐₓ−CRₘᵢₙ)−(Sᵢ/max(S)). The compression may be implemented using a combination of pruning (removing pairs if CRᵢ<CR_{threshold}) and quantization (quantizing to bᵢ=round(bₘₐₓ·(CRᵢ−CRₘᵢₙ)/(CRₘₐₓ−CRₘᵢₙ)) bits). Particular embodiments use a modified version of the ZeroQuant algorithm for efficient quantization, adapting it to handle dynamic bit-widths and leveraging mixed-precision arithmetic to maintain accuracy while reducing memory footprint.

To integrate CALC-LLM with existing architectures, particular embodiments replace the standard attention mechanism and KV-cache with the dynamic sparse attention and adaptive compression modules. The integration process involves, for example, initializing the MGM with pre-trained parameters, generating attention masks at regular intervals or when significant deviations are detected, applying the mask to attention logits, computing sparse attention output using a CUDA kernel, updating positional embeddings using dynamic NTK scaling, and updating and compressing the KV-cache. In particular embodiments, compression may occur through eviction based on the MGM output.

Particular embodiments may employ one or more of several optimizations to maximize efficiency. For example, fused CUDA kernels combine multiple operations (e.g., mask generation with sparse attention, KV-cache compression and decompression) to reduce memory bandwidth usage. Mixed precision computation leverages FP16 for MGM computations and a combination of FP16 and FP32 for sparse attention and KV-cache operations, with careful management of accumulation to maintain numerical stability. In particular embodiments, the precision of value may be Int8 if quantized (or int4 in alternative embodiments, the precision can go as low as needed), or BF16 in GPU when unquantized (in place of FP16, for instance because BF16 is more optimized for GPUs). Other GPU architectures can also use FP8 or FP4. A custom memory pool pre-allocates large chunks of GPU memory, implements a slab allocator for efficient small allocations, and uses memory defragmentation techniques to coalesce free spaces periodically. Adaptive hyper-parameter tuning monitors key metrics (perplexity, attention entropy, memory usage) during inference and adjusts hyper-parameters using Bayesian optimization, with a warm-up period to stabilize estimates.

To handle sequences longer than those seen during pre-training, particular embodiments employ a dynamic positional embedding interpolation technique using Neural Tangent Kernels (NTK) with frequency-scaled temperature. For a new sequence length L>Lₚᵣₑ, such embodiments compute interpolated embeddings as:

$${P}_{new} = K ( {x}_{new} , {x}_{pre} ) {K ( {x}_{pre} , {x}_{pre} )}^{- 1} {P}_{pre} \qquad ( 2 )$$

where K(⋅,⋅) is the NTK with frequency-scaled temperature:

$$K ( x , y ) = {\sum }_{f = 1}^{d / 2} cos ( \frac{2 τ f ( x - y )}{L} ) / τ ( f ) , and \\ τ ( f ) = {τ}_{0} \cdot {f}^{β}$$

with learnable parameters−τ₀ and β.

In particular embodiments, the time complexity of CALC-LLM is T(N)=O(N log N+rN²), where N is the sequence length and r is the sparsity ratio. The space complexity is S(N)=O(rN+N), enabling processing of much longer sequences compared to standard transformers, which typically have a quadratic space complexity.

This disclosure contemplates that the hyperparameters n, m, and k may take various values; for example n=128, m=16, and k may be a dynamic value having a maximum of 64.

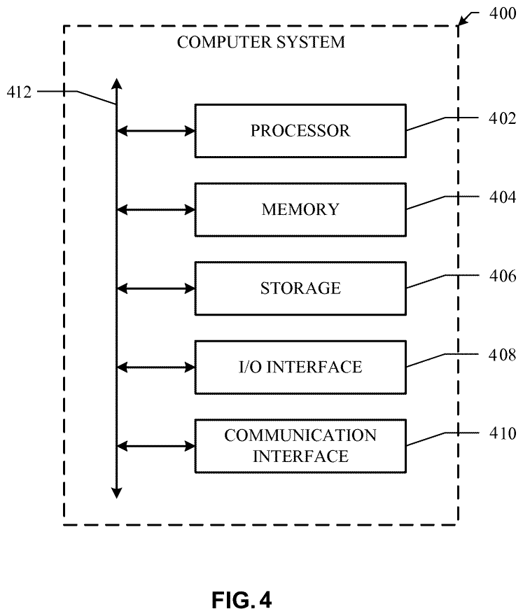

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, memory 404 includes GPU memory (VRAM). Model weights and KV cache are loaded into GPU memory in particular embodiments, as described above.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure contemplates a system that includes one or more non-transitory computer readable storage media storing instructions; and one or more processors coupled to the one or more non-transitory computer readable storage media and operable to execute the instructions to perform certain functions includes embodiments in which those functions are performed by a single processor, embodiments in which those functions are performed by multiple processors that each perform all the functions, and embodiments in which those functions are performed by multiple processors (e.g., in separate computing devices) where each processor performs at least one function but less than all recited functions.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
predicting, by a decoder of an LLM and in response to an input sequence provided to an encoder of the LLM, s tokens of an output sequence;
accessing, for each of one or more attention layers of the LLM, a set of attention logits specific to that attention layer and used by the LLM to predict the n most recent tokens of the s tokens;
determining, for each of the one or more attention layers and by a trained mask generation model, a layer-specific attention mask for the set of attention logits specific to that attention layer, based on the accessed set of attention logits; and
predicting, by the decoder of the LLM, the next m tokens of the output sequence using, for each of the one or more attention layers, the set of attention logits as masked by the layer-specific attention mask for that layer.

2. The method of claim 1, further comprising determining the layer-specific attention mask for each of the one or more attention layers based on the s tokens of the output sequence.

3. The method of claim 1, further comprising, after predicting the m tokens, repeating the accessing, determining, and predicting steps for one or more additional iterations.

4. The method of claim 3, further comprising, for at least one of the additional iterations:
determining, for each of the one or more attention layers, a difference between (1) the set of attention logits as masked by the layer-specific attention mask for that layer and (2) the s tokens of the output sequence for that iteration;
when the difference is less than a threshold, then updating the attention logits for that layer using the layer-specific attention mask; and
when the difference is greater than a threshold, then reverting the attention logits for that layer to that layer's attention logits from a previous iteration.

5. The method of claim 1, further comprising selecting the top k set of attention logits in each of the one or more layers to predict the next m tokens of the output sequence.

6. The method of claim 1, wherein the method is performed by a client device that stores the LLM.

7. The method of claim 1, further comprising determining the layer-specific attention mask and predicting the next m tokens using a CALC-LLM algorithm.

8. The method of claim 1, wherein the set of attention logits are accessed from a KV cache for the respective attention layer; and
the method further comprising compressing the KV cache for the respective attention layer based on the set of attention logits as masked by the layer-specific attention mask for that respective attention layer.

9. The method of claim 1, wherein the trained mask generation model comprises a vision transformer encoder and decoder.

10. A system comprising:
one or more non-transitory computer readable storage media storing instructions; and one or more processors coupled to the one or more non-transitory computer readable storage media and operable to execute the instructions to:
predict, by a decoder of an LLM and in response to an input sequence provided to an encoder of the LLM, s tokens of an output sequence;
access, for each of one or more attention layers of the LLM, a set of attention logits specific to that attention layer and used by the LLM to predict the n most recent tokens of the s tokens;
determine, for each of the one or more attention layers and by a trained mask generation model, a layer-specific attention mask for the set of attention logits specific to that attention layer, based on the accessed set of attention logits; and
predict, by the decoder of the LLM, the next m tokens of the output sequence using, for each of the one or more attention layers, the set of attention logits as masked by the layer-specific attention mask for that layer.

11. The system of claim 10, further comprising one or more processors operable to execute the instructions to determine the layer-specific attention mask for each of the one or more attention layers based on the s tokens of the output sequence.

12. The system of claim 10, further comprising one or more processors operable to execute the instructions to, after predicting the m tokens, repeat the accessing, determining, and predicting steps for one or more additional iterations.

13. The system of claim 12, further comprising one or more processors operable to execute the instructions to, for at least one of the additional iterations:
determine, for each of the one or more attention layers, a difference between (1) the set of attention logits as masked by the layer-specific attention mask for that layer and (2) the s tokens of the output sequence for that iteration;
when the difference is less than a threshold, then update the attention logits for that layer using the layer-specific attention mask; and
when the difference is greater than a threshold, then revert the attention logits for that layer to that layer's attention logits from a previous iteration.

14. The system of claim 10, further comprising one or more processors operable to execute the instructions to select the top k set of attention logits in each of the one or more layers to predict the next m tokens of the output sequence.

15. The system of claim 10, wherein the one or more processors and the computer readable storage media are part of a client device that stores the LLM.

16. The system of claim 10, further comprising one or more processors operable to execute the instructions to determine the layer-specific attention mask and predict the next m tokens by executing a CALC-LLM algorithm.

17. One or more non-transitory computer readable storage media storing instructions that are operable when executed by one or more processors to:
predict, by a decoder of an LLM and in response to an input sequence provided to an encoder of the LLM, s tokens of an output sequence;
access, for each of one or more attention layers of the LLM, a set of attention logits specific to that attention layer and used by the LLM to predict the n most recent tokens of the s tokens;
determine, for each of the one or more attention layers and by a trained mask generation model, a layer-specific attention mask for the set of attention logits specific to that attention layer, based on the accessed set of attention logits; and
predict, by the decoder of the LLM, the next m tokens of the output sequence using, for each of the one or more attention layers, the set of attention logits as masked by the layer-specific attention mask for that layer.

18. The media of claim 17, further comprising instructions that are operable when executed by one or more processors to, after predicting the m tokens, repeat the accessing, determining, and predicting steps for one or more additional iterations.

19. The media of claim 17, wherein the computer readable storage media is part of a client device that stores the LLM.

20. The media of claim 17, further comprising instructions that are operable when executed by one or more processors to determine the layer-specific attention mask and predict the next m tokens using a CALC-LLM algorithm.
